(19) United States
(12) Patent Application Publication
(10) Pub. No.: US 2010/0217789 A1
(43) Pub. Date: Aug. 26, 2010

(54) PHYSICAL RANDOM NUMBER GENERATION METHOD AND PHYSICAL RANDOM NUMBER GENERATOR

(75) Inventors: Yoshiaki Saitoh, Niigata (JP); Takashi Satoh, Niigata (JP)

Correspondence Address: DARBY & DARBY P.C., P.O. BOX 770, Church Street Station, New York, NY, 10008-0770, US

(73) Assignee: NIIGATA UNIVERSITY, NIIGATA (JP)

(21) Appl. No.: 11/917,938

(22) PCT Filed: Oct. 4, 2006
(86) PCT No.: PCT/JP2006/319839

§ 371 Date: Dec. 18, 2007

(30) Foreign Application Priority Data
Jan. 20, 2006 (JP) 2006-013151

(51) Int. Cl. G06F 7/58

(52) U.S. Cl. 708/255

(57) ABSTRACT

There is provided a physical random number generation method and a physical random number generator by which safe random numbers can be obtained at high speed. The physical random number generator comprises a laser equipment which irradiates laser light, a frequency discrimination filter which discriminates frequencies of the laser light, an photodetector which converts intensity of laser light into electric signals, an on-off detector or an A/D converter which converts analogue signals output from the photodetector as a detected result into digital data. First, the laser light irradiated from the laser equipment is allowed to pass through the frequency discrimination filter. Transmitted light changes in intensity depending on frequency fluctuations of the laser light. Then, this intensity of the transmitted light is converted into electric signals by the photodetector to be converted into binary random numbers using the on-off detector or the A/D converter. Finally, the binary random number data thus generated are imported into a PC.

### CROSS REFERENCE TO PRIOR APPLICATIONS

This is a U.S. national phase application under 35 U.S.C. §371 of International Patent Application No. PCT/JP2006/319839, filed Oct. 4, 2006, which claims the benefit of Japanese Application No. 2006-013151, filed Jan. 20, 2006, both of which are incorporated by reference herein. The International Application was published in Japanese on Jul. 26, 2007 as International Publication No. WO 2007/083417 A1 under PCT Article 21(2).

### TECHNICAL FIELD

The present invention relates to a physical random number generation method used in for example a field concerning maintenance of confidentiality in IT technologies as well as a physical random number generator for realizing this method.

### BACKGROUND ART

Heretofore, as disclosed in, e.g., patent document 1, a physical random number generator has been well-known which generates physical random numbers by taking advantage of random phenomena in the natural world. In general, as a noise source of a physical random number generator are often utilized thermal noises or the like in an electronic circuit. The physical random numbers are being utilized in various fields such as in encryption processes or the like aimed at maintaining confidentiality in IT technologies.

Patent document 1: Japanese unexamined patent application publication No. 2000-259395

Conventionally, an electronic circuit was employed as a noise source and hence fluctuation amplitude was small, so that even if the fluctuation amplitude was input to an A/D converter, safe random numbers could be obtained only in small digit number. Further, since an A/D converter using an electronic circuit was conventionally employed, a generation speed of random numbers was in the order of 100M bits/sec to 1 G bits/sec. The inventors of the present invention have been developing a high-speed random number generation method using low-order bits of the A/D converter using the electronic circuit. As a result, however, it was found that the generation speed of the random numbers is at most in the order of 1 G bits/sec at maximum since the generation speed of random numbers depends on the fluctuation frequencies of the noise source and a conversion speed of the A/D converter.

Pursuing high-degree information security, however, requires several hundreds to several thousands of the encryption random numbers for one piece of valid information and hence it is necessary that enormous encryption random numbers must be generated at high speed.

Consequently, with the view to the problems described above, it is an object of the present invention to provide a physical random number generation method and a physical random number generator which are capable of obtaining safe random numbers at high speed.

### SUMMARY OF THE INVENTION

In the physical random number generation method according to the present invention, frequencies of laser light are discriminated and the light thus discriminated is detected and then results of detection thus obtained are converted into numerical values, thus generating random numbers.

The physical random number generator according to the present invention is equipped with a laser equipment which irradiates laser light, a frequency discrimination filter which discriminates frequencies of the laser light, a photodetector which detects transmitted light through the frequency discrimination filter, and a numerical value converter which converts the laser light detected by the photodetector into numeral values.

Thus, a variation in intensity of extremely high-speed light (a change between strengths and weakness) can be obtained from the laser light with large frequency fluctuations. Hence, white noises ranging up to the order of several GHz are contained in the light detected, which is then numerically converted, thereby permitting random numbers to be generated at high speed.

In the physical random number generation method according to the present invention, frequencies of laser light are discriminated and then the laser light after the discrimination is divided into reflected light and transmitted light by using a half mirror and further the reflected light by the half mirror is detected to thereby be converted into numerical values, thus generating random numbers.

Further, the physical random number generator according to the present invention is equipped with a laser equipment which irradiates laser light, a frequency discrimination filter which discriminates frequencies of the laser light, a half mirror which divides transmitted light through the frequency discrimination filter into transmitted light and reflected light, a photodetector which detects the reflected light through the half mirror, and a numerical value converter which converts the light detected by the photodetector into numerical values.

Thus, the A/D converter whose converting speed is limited need not be used and thus random numbers can be generated at extremely high speeds. Further, since the noises emitted from the noise source are divided by using the half mirror of an optical system, random numbers with a more-digit number can be generated at a time as compared to those generated by an electronic circuit.

In the physical random number generation method according to the present invention, frequencies of laser light are discriminated and then the laser light discriminated by using a plurality of half mirrors is divided into reflected light and transmitted light and then the reflected light by the half mirrors is detected by a plurality of photodetectors to convert electric signals output from each of the photodetectors into digital data with the timings of the electric signals shifted from one another by a plurality of A/D converters.

The physical random number generator according to the present invention is equipped with a laser equipment which irradiates laser light, a frequency discrimination filter which discriminates frequencies of the laser light, a plurality of half mirrors which divide transmitted light through the frequency discrimination filter into reflected light and transmitted light, a plurality of photodetectors which detect the reflected light by each half mirror, and a plurality of the A/D converters which convert an electric signal output from each photodetector into digital data. The A/D converters are designed so as to shift A/D conversion timings from one another.

Thus, since noises emitted from a noise source are divided by using half mirrors of an optical system, more-digit random numbers can be generated at a time as compared to those obtained by an electronic circuit. Further, digital data values obtained from each A/D converter can be allowed to differ largely from one another, thus enabling a multiple of random numbers suitable for an encryption process to be obtained.

In the physical random number generation method according to the present invention, frequencies of laser light are discriminated using a light-absorbing material which absorbs light with a specific frequency and a magnetic field or an electric field are applied to the light-absorbing material to thereby control an absorption line property.

Further, in the physical random number generator according to the present invention, the frequency discrimination filter is composed of a light-absorbing material which absorbs light with a specific frequency and is equipped with a magnetic field generation means or an electric field generation means which apply a magnetic field or an electric field, respectively, to the frequency discrimination filter.

Thus, a property of a random-number can be changed by taking advantage of the phenomena where a frequency distribution changes when a magnetic field or an electric field are applied to the light-absorbing material. As a result, there exist a number of random numbers different in statistical property, so that the decryption becomes difficult to fulfill when using the random numbers for the encryption process.

In the physical random number generation method according to the present invention, the laser light comprises a plurality of laser lights different in frequency from one another.

Further, the physical random number generator according to the present invention irradiates a plurality of laser lights different in frequency.

Thus, using a plurality of laser equipments different in frequency enables an incident light dependency of an absorption line property to be alleviated, thus suppressing a difference arising in a property of a variation in intensity of transmitted light.

According to the present invention, a physical random number generation method and a physical random number generator can be provided by which safe random numbers can be obtained at high speed.

Further, according to the present invention, a physical random number generation method and a physical random number generator can be provided by which many-digit random numbers can be generated at a time at extremely high speeds.

Furthermore, according to the present invention, safe random numbers suitable for encryption can be generated.

Moreover, according to the present invention, a difference, which has an adverse effect on a property of binary random numbers, arising in a property of a variation in intensity of transmitted light can be restrained.

### BRIEF DESCRIPTION OF THE DRAWINGS

FIG. 1 is a block diagram illustrating a configuration of a physical random number generator in a first embodiment of the present invention.

FIG. 2 is a block diagram illustrating a configuration of a physical random number generator in a second embodiment of the present invention.

FIG. 3 is a block diagram illustrating a modification of a physical random number generator in the same as above.

FIG. 4 is a block diagram illustrating a configuration of a physical random number generator in a third embodiment of the present invention.

FIG. 5 is a block diagram illustrating a configuration of a physical random number generator in a fourth embodiment of the present invention.

FIG. 6 is a block diagram illustrating a configuration of a physical random number generator in a fifth embodiment of the present invention.

### DETAILED DESCRIPTION OF THE INVENTION

Hereunder are descriptions of embodiments of a physical random number generation method and a physical random number generator according to the present invention with reference to appended drawings. In addition, descriptions common to each of embodiments are omitted as much as possible to avoid overlapping.

The aspects of the present invention are primarily the following two points. (1) As a noise source, semiconductor laser light whose noise is largest among laser lights is mainly used and hence white noises whose fluctuations are large, whose frequency stability is worse and further whose bandwidth is not less than 1 GHz can be obtained, thus permitting safe encryption random numbers to be obtained from many digits (almost all digits). (2) Using light with a much higher frequency than a maximum operating frequency of an A/D converter in an electronic circuit, a dividing operation is practiced. Hence, the operation is rapid and besides a frequency of laser is large in fluctuation and is unstable. Consequently, even if data are obtained at extremely high speeds, a property as the safe encryption random numbers is not lost.

### Embodiment 1

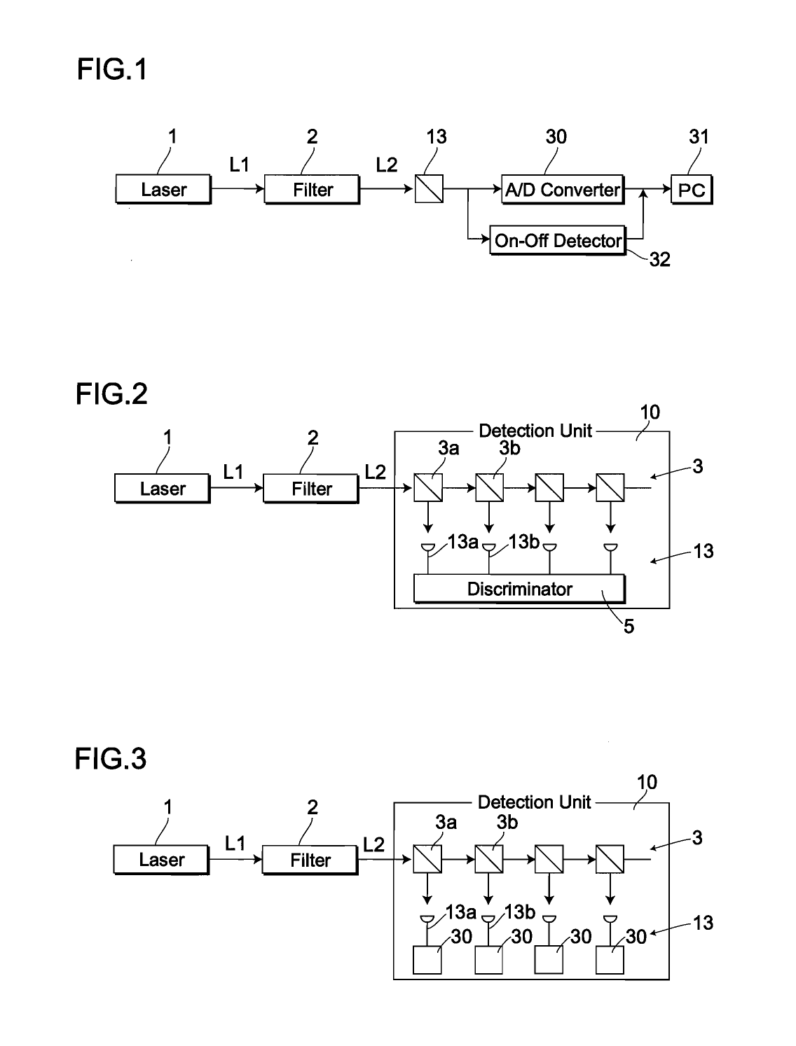

A fundamental configuration of a physical random number generator according to a first embodiment of the present invention is shown in FIG. 1. The physical random number generator in the present first embodiment comprises a laser equipment 1 which irradiates laser light L1 acting as a noise source, a frequency discrimination filter 2 which discriminates frequencies of the laser light L1 irradiated from the laser equipment 1, a photodetector 13 which converts intensity of transmitted light L2 with a given frequency band discriminated by the frequency discrimination filter 2 into electric signals, and an A/D converter 30 which corresponds to a numerical value converter for converting analogue signals output, as the detected result, from the photodetector 13 into digital data. Finally, the digital data obtained here are input to a PC 31 corresponding to an information processor such as a personal computer or the like to be used for various encryption processes as random number data. In the A/D converter 30, if using detection elements operating exclusively for discriminating ON and OFF, an extremely high-speed operation is possible. When the A/D converter 30 has a plurality of digits, a specific one digit may be used. As having a plurality of the digits, however, if the A/D converter 30 utilizes information appeared in each digit as random number data, a multiple of random number data can be obtained.

In the present invention, the laser light L1 is employed as a noise source. In general, however, a semiconductor laser exhibits a property where “frequency fluctuations in laser light” (frequency noises) are prominently observed and hence the laser equipment 1 is preferable which irradiates semiconductor laser. Obviously, if a laser source exhibits large “frequency fluctuations in laser light”, any laser source such as gas laser source or the like can be employed as the noise source.

The frequency discrimination filter 2 comprises cells in which sealed are light-absorbing materials, such as cesium, rubidium or the like, with a property of absorbing laser light having a specific frequency. Then, as the frequency discrimination filter 2, various types of optical filters such as an optical interference filter, the Fabry-Perot filter or like can be also employed.

Hereunder is a description of behavior of the foregoing system, together with procedures of the physical random number generation.

First, the laser light L1 irradiated from the laser equipment 1 is allowed to pass through the frequency discrimination filter 2. Making the laser light L1 with large frequency fluctuations pass through the frequency discrimination filter 2, intensity of the laser light transmitted therethrough varies depending on the frequency fluctuations of the laser light L1. When the frequency of the laser light L1 is fluctuating near at light-absorbing frequencies of the atoms of, e.g., cesium, rubidium or the like, there occurs alternate high-speed switching between states in which the laser light L1 is absorbed and is not absorbed. This laser light generated after being subjected to the high-speed switching acts as transmitted light L2 through the frequency discrimination filter 2 to cause a rapid change in intensity of the transmitted light L2. In other words, the frequency discrimination filter 2 operates as a light parameter conversion means which performs the conversion from the frequency fluctuations of the laser light L1 to light intensity fluctuations of the transmitted light L2. In addition, when the optical interference filter, the Fabry-Perot filter or the like is employed, such optical filters change generally intensity of transmitted light depending on a change in frequency of laser light and all the same cause a rapid change in the intensity of the transmitted light L2 through the frequency discrimination filter 2.

Next, the intensity of the transmitted light L2 is converted by the high-speed photodetector 13 into an electric signal, such as a voltage or the like. When using an on-off detector 32 performing on-off operations, the output of the on-off detector 32 acts directly as a binary output. The output can be also converted into binary random numbers by using the A/D converter 30. At this time, an output at a binary output terminal of the A/D converter 30 acts directly as a binary random number. Then, the binary random number data are imported into the PC 31. In addition, focusing attention on a certain digit of the binary random number data output from the A/D converter 30, random numbers can be also created using “0s” and “1s” output in a time-series manner. Likewise, focusing attention on each digit of the binary random number data, random numbers can be also generated. This approach is more effective than the use of “0s” and “1s” since the random numbers can be generated using low-order bits even when high-order bits are not allowed to pass a statistical screening.

In the physical random number generator of the present embodiment, extremely-high-speed intensity fluctuations of the transmitted light L2 can be obtained by making the laser light L1 with large frequency fluctuations pass through the frequency discrimination filter 2 using the laser equipment 1. Hence, white noises extending to several GHz are contained in a voltage obtained by the photodetector 13 to permit random numbers to be generated at extremely high speeds using the on-off detector 32. Besides, by performing A/D conversion by the A/D converter 30, random numbers can be generated at high speed.

As described above, the physical random number generation method of the present first embodiment is characterized in that the frequency of the laser light L1 is discriminated to detect the transmitted light L2 after the discrimination and then the laser light detected is converted into numeral values, thus generating random numbers.

Further, the physical random number generator of the present first embodiment is characteristically equipped with the laser equipment 1 which irradiates the laser light L1, the frequency discrimination filter 2 which discriminates the frequency of the laser light L1, the photodetector 13 which detects the transmitted light L2 through the frequency discrimination filter 2, and the on-off detector 32 or the A/D converter 30 which corresponds to a numerical value converter for converting the laser light detected by the photodetector 13 into numeral values.

Consequently, the intensity fluctuations of the extremely-high-speed transmitted light L2 can be obtained from the laser light L1 with large frequency fluctuations. Hence, the white noises extending to several GHz are contained in the laser light detected by the transmitted light L2, thus permitting random numbers to be rapidly generated by performing the numerical conversion of the laser light detected. Accordingly, a physical random number generation method and a physical random number generator can be provided which are capable of obtaining safe random numbers at high speed.

### Embodiment 2

A fundamental configuration of a physical random number generator of a second embodiment in the present invention is shown in FIG. 2. The physical random number generator of the present second embodiment comprises a laser equipment 1, a frequency discrimination filter 2, and a detection unit 10 described later. Digital data finally obtained by the detection unit 10 are used for various types of encryption processes as random numbers in an information processor such as a personal computer or the like.

Now, the configuration of the detection unit 10 is detailed. The detection unit 10 is equipped with a plurality of half mirrors 3, a plurality of photodetector 13, and a discriminator 5 which corresponds to a numeral value converter comprising, e.g., a comparator or the like for discriminating a “0” or a “1” of a binary number from magnitude of laser light detected by the photodetector 13. In the half mirror 3, a plurality of half mirrors 3a, 3b . . . which divide incident light into reflected light and transmitted light in halves is arranged side by side. The photodetectors 13a, 13b . . . are provided in the detection unit 10 so as to pair with the half mirrors 3a, 3b . . . , respectively. The pairs are repeatedly provided in such numbers as the transmitted light is decayed for the photodetector 13 not to operate. An A/D converter can be also employed instead of the comparator.

Hereunder is a description of behavior exercised by the above configuration together with a procedure of random number generation.

Laser light L1 output from the laser equipment 1 is allowed to pass through the frequency discrimination filter 2. The description that has been given till the light intensity changes rapidly is the same as that in the first embodiment shown in FIG. 1. In the present second embodiment, the detection unit 10 is connected to a stage posterior to the frequency discrimination filter 2 to allow transmitted light L2 output from the frequency discrimination filter 2 to pass the half mirror 3a of the detection unit 10. Half the transmitted light L2 is reflected at the half mirror 3a to reach the photodetector 13a, while the other half reaches the next half mirror 3b. Then, the reflected light by the half mirror 3b reaches the photodetector 13b. This operation is continued till the photodetector 13 becomes not alive. An on-off operation is performed in such a manner that when exceeding a given level (a threshold value), a signal output from the photodetector 13 is allowed to correspond to an binary “0”, whereas when not exceeding, the output signal is allowed to correspond to an binary “1”.

In the present technology, the transmitted light L2 which has passed through the frequency discrimination filter 2 is easy to reach 100 mW and besides the photodetector 13 can detect a signal up to 100 mW. Hence, in this case, 19 half mirrors are employed to enable a binary random number of 20 digits to be obtained. Besides, the binary random number of 20 digits can be processed at high speed of 10 GHz.

Needles to say, focusing on a certain digit, a random numerical sequence can be also created by using “0s” and “1s” which appear at a certain time interval (e.g., 1 ns) in a time-series manner. If random numbers are generated by focusing on each digit, a random numerical sequence with the digit number can be created at a time. This method is more effective than the method described last since random numbers can be generated using low-order bits even when high-order bits are not allowed to pass a statistical screening.

In the present second embodiment, an A/D converter is not employed whose conversion speed is limited and hence random numbers can be generated at extremely high speeds. Further, the use of the optical system enables a random number with a more-digit number to be generated at a time as compared to the digit number generated by an electronic circuit.

As a modification of the present second embodiment, the A/D converter 30 can be also employed as shown in FIG. 3 instead of the discriminator 5 in the configuration shown in FIG. 2. In this case, e.g., a sampling frequency of each A/D converter 30 is set to be different from each other and a delay circuit, which delays signal transmission from the photodetector 13, is interposed between the photodetector 13 and the A/D converter 30, and so on. As a result, sampling (data obtaining) timing of the signal output from the photodetector 13 is shifted in each A/D converter 30. By making the sampling timing of each A/D converter 30 asynchronous, the values of digital data obtained from each A/D converter 30 can be made largely different from one another, permitting a number of random numbers suitable for the encryption process to be obtained.

As stated above, the physical random number generation method of the present second embodiment is characterized by the processes in which the frequencies of the laser light L1 are discriminated to divide the transmitted light L2 after the discrimination into transmitted light and reflected light using a plurality of the half mirrors 3 and then the reflected light by the half mirrors 3 is detected to be converted into numerical values, thus generating random numbers.

Further, the physical random number generator in the present second embodiment is characterized by including the laser equipment 1 which irradiates the laser light L1, the frequency discrimination filter 2 which discriminates the frequencies of the laser light L1, the half mirrors 3 which divide the transmitted light L2 through the frequency discrimination filter 2 into the reflected light and the transmitted light, the photodetector 13 which detects the reflected light by the half mirror 3, and the discriminator 5 which corresponds to the numerical value converter for converting the laser light detected by the photodetector 13 into numerical values.

Thus, the A/D converter 30 whose conversion speed is limited need not be used to enable random numbers to be generated at extremely high speeds. Besides, noises from the noise source are divided using optical-system half mirrors and hence random numbers with the more-digit number can be generated at a time as compared to the digit number generated by en electronic circuit. Consequently, the physical random number generation method and the physical random number generator can be provided which can generate random numbers with a more-digit number at a time at extremely high speeds.

The physical random number generation method in the modification of the present second embodiment is characterized by the processes in which the frequencies of the laser light L1 are discriminated to divide the transmitted light L2 after the discrimination into reflected light and transmitted light using a plurality of the half mirrors 3 and then the light reflected by each half mirror 3 is detected by a plurality of the photodetectors 13 to convert, by a plurality of the A/D converter 30, electric signal output from each photodetector 13 into digital data with each timing of the electric signal shifted, thus generating random numbers.

Further, the physical random number generator in the present second embodiment is characterized by including the laser equipment 1 which irradiates the laser light L1, the frequency discrimination filter 2 which discriminates the frequencies of the laser light L1, the plurality of the half mirrors 3 which divide the transmitted light L2 through the frequency discrimination filter 2 into the reflected light and the transmitted light, the photodetector 13 which detects the reflected light by the half mirror 3, and the plurality of the A/D converter 30 which converts the electric signal output from each photodetector 13 into digital data, and each A/D converter 30 is designed to shift the timing of the A/D conversion from one another.

Thus, since noises of the noise source are divided using the optical-system half mirrors 3 and thereby random numbers with a more-digit number at a time as compared to the digit number generated by an electronic circuit. Further, digital data values obtained from each A/D converter 30 can be made largely different from one another to permit a large quantity of random numbers suitable for the encryption process to be obtained. Consequently, the physical random number generation method and the physical random number generator can be provided which can generate a large quantity of random numbers with a more-digit number at a time at extremely high speeds.

In addition, an amplifier is installed at a stage subsequent to the photodetector 13 and then can be connected to the discriminator 5. If employing the plurality of the A/D converters 30 instead of the discriminator 5, the A/D converters 30 have a number of digits, a large quantity of random numbers can be obtained as a result.

### Embodiment 3

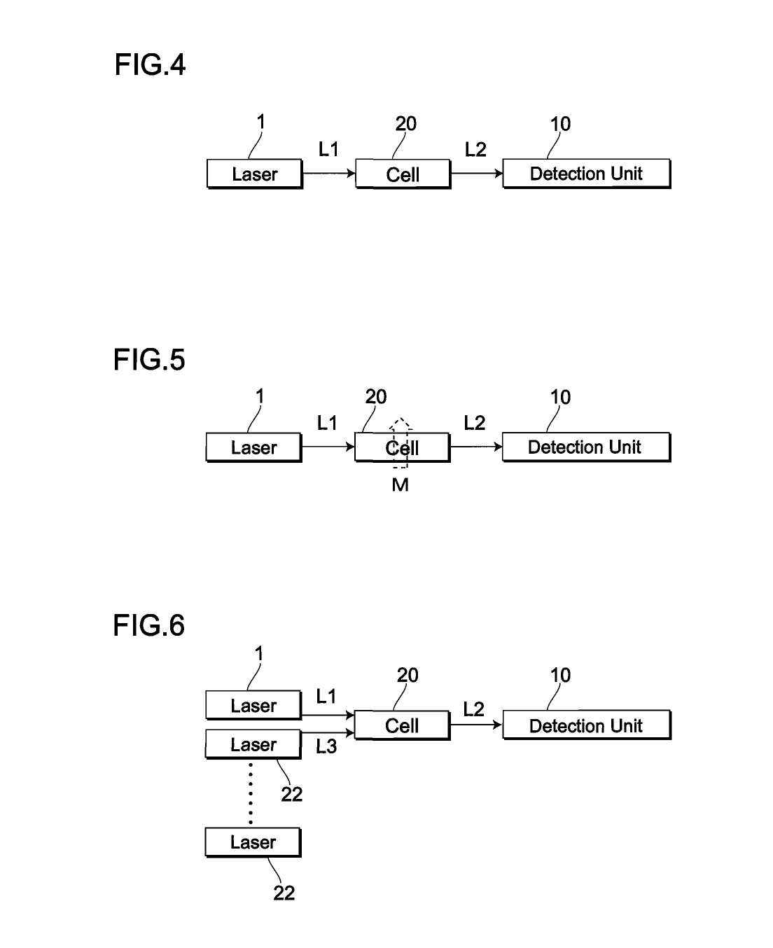

A fundamental configuration of a physical random number generator of a third embodiment in the present invention is shown in FIG. 4. The physical random number generator of the present third embodiment comprises a laser equipment 1, a cell 20 which corresponds to a frequency discrimination filter for discriminating frequencies of laser light L1 irradiated from the laser equipment 1, and a detection unit 10. In the present third embodiment, as a frequency discrimination filter, e.g., the cell 20 in which cesium and rubidium are sealed is employed and at a stage subsequent to the cell 20, the detection unit 10 is employed to generate random numbers. The detection unit 10 has the same configuration as that shown in FIG. 2. Then, digital data obtained by the detection unit 10 is utilized in an information processing device such as a personal computer for various types of encryption processes as random number data.

With respect to the above configuration, the description that has been given till the light intensity changes rapidly is the same as that in the first embodiment. Besides, light detection by the detection unit 10 is the same as that in the second embodiment.

In the present third embodiment, by utilizing laser light with fluctuation frequencies near absorbing frequencies of the cell 20 in which cesium and rubidium are sealed, extremely abrupt light intensity can be obtained to enable high-speed random number generation.

### Embodiment 4

A fundamental configuration of a physical random number generator of a fourth embodiment in the present invention is shown in FIG. 5. In FIG. 5, in addition to the configuration shown in FIG. 4, a magnetic field M (or may be an electric field) is applied externally to the cell 20. By applying, e.g., a magnetic field or an electric field externally to the cell 20 in which cesium and rubidium are sealed, transmitted light L2 changes in frequency distribution. This phenomenon is well-known as Zeeman effect, while in the fourth embodiment, a property of a binary random number can be changed using a change in frequency distribution of the transmitted light L2. As a result, there exist many random numbers with different statistical properties and thereby when employing the random numbers for an encryption process, its decryption becomes difficult.

As stated above, the physical random number generation method of the fourth embodiment is characterized by the processes in which using the cell 20 in which light-absorbing materials for absorbing light with a specific frequency are sealed, the frequencies of the laser light L1 are discriminated and besides by applying a magnetic field or an electric field to the cell 20, the absorption lines are controlled.

Further, the physical random number generator of the present fourth embodiment is characterized by including the cell 20 in which the light-absorbing materials where light with a given frequency is absorbed by the frequency discrimination filter are sealed, and a magnetic field generation means or an electric field generation means which apply a magnetic field or an electric field, respectively, to the cell 20 acting as a frequency discrimination filter.

Thus, by taking advantage of the phenomenon where a change in frequency distribution occurs when applying a magnetic field or an electric field to the light-absorbing materials sealed in the cell 20, properties of random numbers can be changed. As a result, there exist many random numbers with different statistical properties and thereby when the random numbers are utilized for an encryption process, its decryption becomes difficult. Accordingly, safe random numbers suitable for the encryption process can be generated

### Embodiment 5

A fundamental configuration of a physical random number generator of a fifth embodiment in the present invention is shown in FIG. 6. In FIG. 6, in addition to the configuration shown in FIG. 4 or FIG. 5, laser equipments 22 with different frequencies are added in addition to the laser equipment 1 to excite the cell 20 optically, thus controlling the property of the transmitted light L2. Two (or more) laser lights with different fluctuation properties are combined and thereby more complicated frequency fluctuations occur to enable higher-speed random number generation. In the case of only one laser equipment 1 provided, when employing the cell 20 as the frequency discrimination filter, the properties of the absorption lines are changed by incident light in some cases. As a result, there is possibility of giving rise to a difference between properties of a change in intensity of the transmitted light L2 immediately after laser light L1 has been incident and a short time later and the difference might have an adverse effect on a quality of binary random numbers. To avoid this adverse effect, the addition of the laser equipment 22 alleviates incident-light dependence of the property of the absorption line to be able to restrain a difference in change of a property of intensity of the transmitted light. This frequency distribution is easier to pass a statistical random number screening.

As stated above, the physical random number generation method of the fifth embodiment is characterized by the laser light, acting as a noise source, comprising a plurality of the laser lights L1, L3 with different frequencies.

Further, the physical random number generator of the fifth embodiment is characterized by irradiating a plurality of the laser lights L1, L3 with different frequencies.

Thus, by employing the plurality of the laser equipments 1, 22 with different frequencies, random numbers can be generated at higher speed and besides the incident-light dependence of the property of the absorption lines is alleviated, thus permitting the difference generated in a property of a change of the intensity of the transmitted light to be restrained.

In addition, the present invention is not limited to each embodiment described above and modifications are possible within the scope not departing from the gist of the present invention. It may be schemed that binary random numbers obtained by the physical random number generation method and the physical random number generator are combined or subjected to an arithmetic operation or the like to thereby generate final random number data.

1. A physical random number generation method, comprising the steps of:
discriminating frequencies of laser light;
detecting light obtained after the discrimination; and
converting a detection result thus obtained into numerical values, thus generating physical random numbers.

2. The physical random number generation method according to claim 1, wherein said light to be detected is reflected light generated by dividing said light obtained after the discrimination into reflected light and transmitted light using half minors.

3. The physical random number generation method according to claim 1, wherein said light obtained after the discrimination is divided into reflected light and transmitted light using half mirrors, and then said reflected light from said each half minor is detected by means of a plurality of photodetectors, and then electric signals output from said each photodetector are converted into digital data with each of said electric signals shifted in timing by a plurality of A/D converters, thereby generating said random numbers.

4. The physical random number generation method according to claim 1, wherein frequencies of said laser light are discriminated using a light-absorbing material which absorbs light with a specific frequency and wherein absorption lines of said light-absorbing material are controlled by applying at least one of a magnetic field or an electric field to said light-absorbing material.

5. The physical random number generation method according to claim 2, wherein frequencies of said laser light are discriminated using a light-absorbing material which absorbs light with a specific frequency and wherein absorption lines of said light-absorbing material are controlled by applying at least one of a magnetic field or an electric field to said light-absorbing field.

6. The physical random number generation method according to claim 3, wherein frequencies of said laser light are discriminated using a light-absorbing material which absorbs light with a specific frequency and wherein absorption lines of said light-absorbing material are controlled by applying at least one of a magnetic field or an electric field to said light-absorbing field.

7. The physical random number generation method according to claim 1, wherein said laser light comprises a plurality of laser lights with different frequencies.

8. A physical random number generator comprising:
a laser equipment which irradiates laser light;
a frequency discrimination filter which discriminates frequencies of said laser light:
one or more photodetectors which detect transmitted light that passes through said frequency discrimination filter, and
a numerical value converter which converts a detection result obtained by said photodetector into numerical values.

9. The physical random number generator according to claim 8, comprising:
one or more half mirrors which divide transmitted light, which has passed through said frequency discrimination filter, into transmitted light and reflected light; and
a numerical value converter which converts a detection result obtained by said photodetector into numerical values,
wherein said photodetector detects said reflected light by said half minor.

10. The physical random number generator according to claim 8, further comprising:
a plurality of half mirrors which divide said transmitted light through said frequency discrimination filter into reflected light and transmitted light, end
a plurality of said photodetectors to detect reflected light from each half mirror, and
wherein said numerical value converter comprises a plurality of A/D converters that are designed to convert electric signals output from said each photodetector into digital data in such a manner that timings of said A/D conversions are shifted from one another.

11. The physical random number generator according to claim 8, wherein said frequency discrimination filter is composed of a light-absorbing substance which absorbs light with a given frequency, said frequency discrimination filter including at least one of a magnetic field generation means or an electric filed generation means which applies at least one of a magnetic field or an electric field to said frequency discrimination filter, respectively.

12. The physical random number generator according to claim 9, wherein said frequency discrimination filter is composed of a light-absorbing substance which absorbs light with a given frequency, said frequency discrimination filter including at least one of a magnetic field generation means or an electric filed generation means which applies at least one of a magnetic field or an electric field to said frequency discrimination filter, respectively.

13. The physical random number generator according to claim 10, wherein said frequency discrimination filter is composed of a light-absorbing substance which absorbs light with a given frequency, said frequency discrimination filter including at least one of a magnetic field generation means or an electric filed generation means which applies at least one of a magnetic field or an electric field to said frequency discrimination filter, respectively.

14. The physical random number generator according to claim 8, said laser equipment irradiates a plurality of laser lights with different frequencies.
